(19) United States
(12) Patent Application Publication
(10) Pub. No.: US 2015/0120806 A1
(43) Pub. Date: Apr. 30, 2015

(54) METHOD FOR ONLINE DISTRIBUTION OF 3D MODEL FILES FOR PRINTING 3D MODELS

(71) Applicant: Aztek, Inc., Irvine, CA (US)

(72) Inventor: Evan Phillips Lippincott, Irvine, CA (US)

(73) Assignee: Aztek, Inc., Irvine, CA (US)

(21) Appl. No.: 14/063,160

(22) Filed: Oct. 25, 2013

(51) Int. Cl. H04L 29/08; G06F 17/50; H04L 29/06

(52) U.S. Cl. CPC H04L 67/06; H04L 67/42; G06F 17/50
USPC 709/203

(57) ABSTRACT

There is provided a method for online distribution of 3D model files for printing 3D models. The method includes establishing a designer account with a designer user. The method includes receiving from the designer user a 3D model file defining printer specifications for the printing of the 3D model file. The method includes compiling a prohibited list of prohibited 3D models. The method includes comparing the received 3D model file with the prohibited list for matches between the 3D model file and the prohibited 3D models of the prohibited list. The method includes establishing a client account with a client user. The method includes making the received 3D model file available for selection by the client user only if the 3D model file is not matched with any of the prohibited 3D models of the prohibited list.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Technical Field

The present disclosure relates generally to printing of 3D model files, and more particularly, to a method of providing 3D model files available for selection by client users.

2. Related Art

3D printing or additive manufacturing is a process of making a three-dimensional solid object from a digital 3D model. 3D printing is achieved using an additive process, where successive layers of material are laid down in different shapes. A designer creates a 3D model using a 3D software application, including computer aided design (CAD) software that generates a 3D model file. A standard data interface between CAD software and the machines is the STL file format. An STL file approximates the shape of a part or assembly using triangular facets or meshes. Examples of other file formats include OBJ, X3D, Collada, VRML (WRL), and PLY.

Additive manufacturing (3D printing) starts with device reading a 3D model design from a 3D model file. The device (generally referred to as 3D printer) effectively “slices” the 3D model in to digital cross-sections for a device to successively use as a guideline for printing. Depending on the device utilized, material or a binding material is deposited on the build bed or platform until material/binder layering is complete and the final 3D model has been “printed.” The device lays down successive layers of liquid, powder, paper or sheet material to build the 3D model from a series of cross sections. These layers, which correspond to the virtual cross sections from the 3D model, are joined or automatically fused to create the final shape.

A number of additive processes are now available. Such processes differ in the way layers are deposited to create parts and in the materials that can be used. Some methods melt or soften material to produce the layers, e.g. selective laser melting (SLM) or direct metal laser sintering (DMLS), selective laser sintering (SLS), fused deposition modeling (FDM), while others cure liquid materials using different sophisticated technologies, e.g. stereolithography (SLA). With laminated object manufacturing (LOM), thin layers are cut to shape and joined together (e.g. paper, polymer, metal). As such, as used herein the term 3D model is intended to broadly refer to any three-dimensional object that is created from a device using an additive process that is based upon an input computer file.

3D printers varies widely in terms of cost of the 3D printer itself, cost to build/print a 3D model, and the desired features of the end printed 3D model, including granularity of detail, material type, texture, color and size. As such, an end user may utilize the 3D printing services from a wide array of 3D printer vendors depending upon the requirements of the 3D model.

Web-based e-commerce of services is popular across a wide demographic of users, and the field in general is experiencing substantial growth. Online customers are able to benefit from the efficiencies obtained through obtaining services from online service providers or vendors.

Accordingly, there is a need in the art for an improved method of 3D printing in comparison to the prior art.

### BRIEF SUMMARY

In accordance with various embodiments of the present disclosure, there is provided a method for online distribution of 3D model files for printing 3D models. The method includes establishing a designer account, via a computer network, with a designer user. The method further includes receiving from the designer user, via a computer network, a 3D model file. The 3D model file defines printer specifications for the printing of the 3D model file. The method further includes compiling a prohibited list of prohibited 3D models. The method further includes comparing the received 3D model file with the prohibited list for matches between the 3D model file and the prohibited 3D models of the prohibited list. The method further includes establishing a client account, via a computer network, with a client user. The method further includes making the received 3D model file available, via a computer network, for selection by the client user only if the 3D model file is not matched with any of the prohibited 3D models of the prohibited list.

The prohibited 3D models include weapons, such as gun components. The method may include encrypting the received 3D model file. The method may include receiving a selection of the 3D model file, via a computer network, by the client user. The method may include transmitting to the client user, via a computer network, print specification data for printing a 3D model with the transmitted print specification data being correlated to the selected 3D model file. The method may include transmitting to the client user, via a computer network, the selected 3D model file. The method may include printing the selected 3D model file. The method may include transferring to the user client the printed 3D model file. The method may include establishing a plurality of print vendor accounts respectively with a plurality of print vendor users, and receiving from each of the print vendor users printer capabilities specifications defining 3D model printer capabilities. The establishing of the plurality of print vendor accounts may be via a computer network. The receiving of the printer capabilities specifications may be via a computer network.

The method may further include determining printer requirements for the received 3D model file, and comparing the printer requirements for the received 3D model file with the printer capabilities specifications for compatibility matches. The method may further include providing information regarding the print vendor users to the client user only for those print vendor users that have compatibility matches between the printer requirements for the received 3D model file and the printer capabilities specifications.

The method may include receiving a selection of the 3D model file, via a computer network, by the client user, and receiving a selection of a print vendor user by the client user for printing of the selected 3D model file. The method may include determining printer requirements for the received 3D model file, and receiving a selection of the 3D model file, via a computer network, by the client user. The method may include receiving from the client user, via a computer network, printer capabilities specifications defining 3D model printer capabilities associated with the client user, and comparing the printer requirements for the selected 3D model file with the printer capabilities specifications for a compatibility match.

According to another embodiment of the present invention, there is provided a method for online distribution of 3D model files for printing 3D models. The method includes establishing a designer account, via a computer network, with a designer user. The method further includes receiving from the designer user, via a computer network, a 3D model file, the 3D model file defining printer specifications for the printing of the 3D model file. The method further includes establishing a client account, via a computer network, with a client user. The method further includes making the received 3D model file available, via a computer network, for selection by the client user. The method further includes receiving a selection of the 3d model file, via a computer network, by the client user. The method further includes establishing a plurality of print vendor accounts respectively with a plurality of print vendor users. The method further includes receiving from each of the print vendor users printer capabilities specifications defining 3D model printer capabilities. The method further includes determining printer requirements for the received 3D model file. The method further includes comparing the printer requirements for the received 3D model file with the printer capabilities specifications for compatibility matches. The method further includes providing information regarding the print vendor users to the client user only for those print vendor users that have compatibility matches between the printer requirements for the received 3D model file and the printer capabilities specifications.

According to various embodiments, the method may further includes receiving a selection of a print vendor user by the client user for printing of the selected 3D model file. The method may further include receiving from the client user, via a computer network, printer capabilities specifications defining 3D model printer capabilities associated with the client user. The method may further include comparing the printer requirements for the selected 3D model file with the printer capabilities specifications associated with the client user for a compatibility match. The method may further include transmitting to the client user print specification data for printing a 3D model associated with the selection.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a symbolic diagram illustrating one exemplary networked computing environment in which various embodiments of the present disclosure may be implemented, including a method of obtaining and providing 3D printing related services;

FIG. 2 is a flowchart illustrating a method for printing 3D models in accordance with one embodiment of the present disclosure;

FIG. 3 is a flowchart illustrating additional steps of the method for printing 3D models in accordance the flowchart of FIG. 2;

FIG. 4 is a flowchart illustrating additional steps of the method for printing 3D models in accordance the flowchart of FIG. 2;

FIG. 5 is a flowchart illustrating additional steps of the method for printing 3D models in accordance the flowchart of FIG. 2;

FIG. 6 is a flowchart illustrating additional steps of the method for printing 3D models in accordance the flowchart of FIG. 2;

FIG. 7 is a flowchart illustrating a method for printing 3D models in accordance with another embodiment of the present disclosure.

FIG. 8 is a flowchart illustrating additional steps of the method for printing 3D models in accordance the flowchart of FIG. 7;

FIG. 9 is a flowchart illustrating additional steps of the method for printing 3D models in accordance the flowchart of FIG. 7;

Common reference numerals are used throughout the drawings and the detailed description to indicate the same elements.

### DETAILED DESCRIPTION

An online networking platform and methods for the printing of 3D model files is disclosed. The detailed description set forth below in connection with the appended drawings is intended as a description of the several presently contemplated embodiments of these systems, platforms, and methods, and is not intended to represent the only form in which the disclosed invention may be developed or utilized. The description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

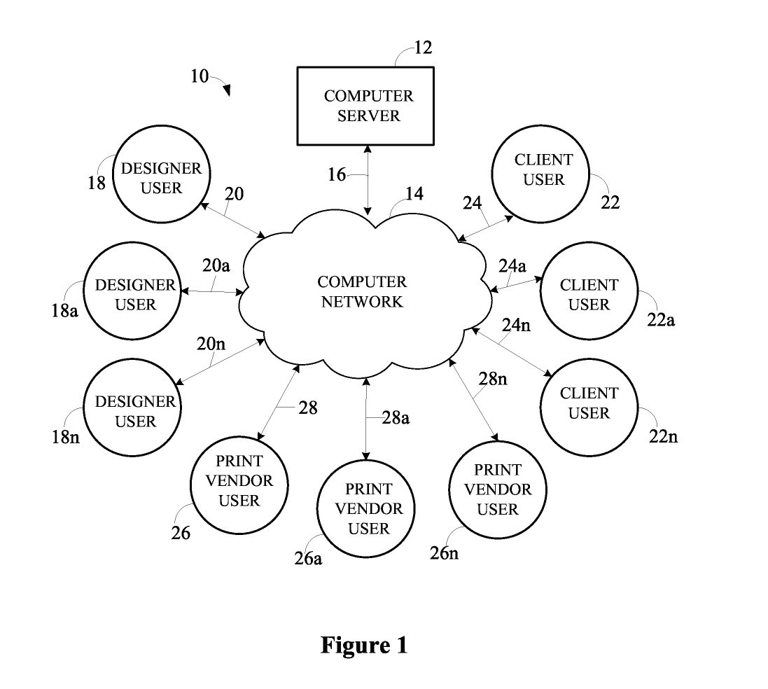

FIG. 1 is a symbolic diagram illustrating one exemplary networked computing environment 10 in which various embodiments of the present disclosure may be implemented. The networked computer environment 10 includes a computer server 12 that includes an online computer platform in accordance with aspects of the present invention. The computer server 12 is in operable communications with a network 14. Generally, there is understood to be a variety of computer systems that are interconnected via a network 14 such as the publicly accessible Internet. While the network 14 is referred to in the broadest sense as encompassing any link over which data communications may be proceed between network nodes, presently, the network 14 solely has the existing infrastructure of independently operated servers for implementing the functionality of the communications and interactions with other online users in accordance with the present disclosure.

The computer server 12 may be a World Wide Web (Web) server that processes requests from the client web browser applications and deliver requested Hypertext Markup Language (HTML) pages as briefly described above. The computer server 12 may be computer systems with processors, memory, data storage devices, and network interface devices that run and are managed by an operating system and run web application servers. It will be recognized that in addition to serving static hypertext documents, interactive web-based applications can be implemented on the computer server 12. It is contemplated that the computer service 12 may be implemented in a dedicated environment via a dedicated private computer network 14. Whether interactions with the computer server are in the nature of a web application or as a private network, the computer server 12 may perform the various steps that embody the methods of the present disclosure as further described herein.

There is provided a designer user 18. A plurality of other designer users, collectively symbolically denoted as 18a-n, may also be provided. The designer users 18 and 18a-n may each be engaged with the network via links 20 and 20a-n. In this regard, each designer user 18 and 18a-n may each have one or more communications devices that electronically connect to the network 14. The communications device may be a conventional personal computer device including a central processing unit, memory, and various input and output devices such as keyboards, mice, and display units. It is understood that each such device may be any number of computing devices capable of electronic communications with the network 14, such as a workstation, a tablet computing device, a notebook computer, portable device, tablet, smartphone or any other suitable data processing apparatus that may be implemented functionality contemplated in the present disclosure as described more fully below.

The communications devices associated with each of the designer users 18 and 18a-n may each have executable instructions of a web browser application that are loaded thereon. The web browser applications are configured to communicate with the computer server 12 also connected to the network 14 over the hypertext transfer protocol (HTTP), among other protocols known in the art. Requests for data are initiated by the communications devices and transmitted to the computer server 12, which in turn transmits the requested data back to the communications devices. In certain embodiments such as where the communication devices take the form of a mobile device capable of executing standalone applications, there may not be a need for a specific web browser application. Further, in a conventional desktop computing environment it is also possible to utilize dedicated applications to access the network 14 and the computer server 12 connected thereto.

There is provided a client user 22. A multitude of client users, collectively symbolically denoted as 22a-n, may also be provided. The client users 22 and 22a-n may each be engaged with the computer network 14 respectively via links 24 and 24a-n. In this regard, each designer user 18 and 18a-n may each have one or more communications devices that electronically connect to the network 14 in a similar manner as the communications devices associated with any of the designer users 18 and 18a-n described above.

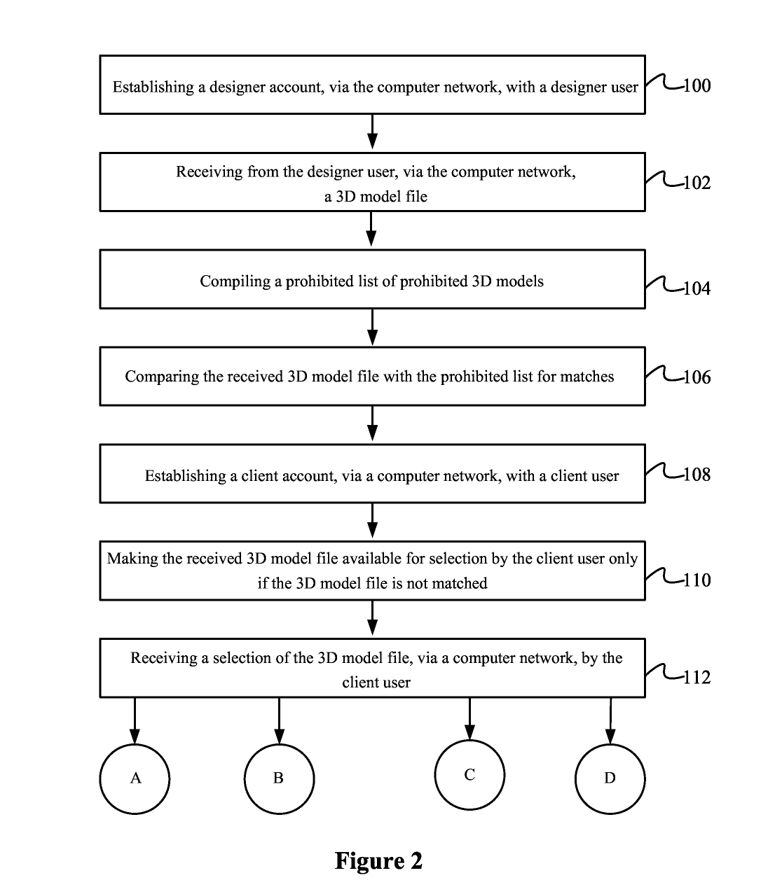

Referring now to FIG. 2 there is depicted a flowchart illustrating a method for online distribution of 3D model files for printing 3D models. In this regard, the method may be effectuated by a computer platform as implemented via the exemplary computer server 12. The computer server 12 is used to symbolically broadly indicate a computer platform that may include a combination of variously hardware and software components and database elements that may be collocated or electronically connected and physically separate.

The method initially includes step 100 of establishing a designer account, via the computer network 14, with a designer user, such as designer user 18. The method further includes step 102 of receiving from the designer user 18, via the computer network 14, a 3D model file. The 3D model file defines printer specifications for the printing of the 3D model file. The method further includes step 104 of compiling a prohibited list of prohibited 3D models. The method further includes step 106 of comparing the received 3D model file with the prohibited list for matches between the 3D model file and the prohibited 3D models of the prohibited list. The method further includes step 108 of establishing a client account, via a computer network, with a client user, such as client user 22. The method further includes step 110 of making the received 3D model file available, via a computer network, for selection by the client user only if the 3D model file is not matched with any of the prohibited 3D models of the prohibited list.

The foregoing method facilitates the establishment of an online eco-system or marketplace in which the designer users, such as designer user 12, may distribute their 3D model files for potential selection by client users, such as client user 22. Further, the method provides a safe way for the client user 22 to obtain selected 3D model printing services, and/or 3D model files or print specification data for printing a 3D model for 3D models which are compliant with or otherwise screened of prohibited models.

As mentioned above, the method initially includes step 100 of establishing a designer account, via the computer network 14, with the designer user 18. The designer account may include a unique account identifier and a related password. As is common place with most any online accounts this would be simply understood as the user name and password. The unique account identifier and password would allow the designer user 18 to “log on” to the computer platform in order to access and interact with the designer account as hosted by the server computer 12. It is contemplated that the designer user 18 may be an individual or other entity that utilizes the unique account identifier to establish or access the account or is otherwise the account holder. It will be appreciated that an arbitrary number of user accounts may be established, and need not be limited to the example designer users 18 or 18a-n.

As mentioned above, the method further includes step 102 of receiving from the designer user 18 the 3D model file. The computer server 12 is contemplated to receive the 3D model file via the computer network 14. This may be effectuated through an online submittal process with the designer user 12 uploading the proposed 3D model file to the computer network 14 using the link 24 for receipt by the computer server 12. The 3D model file may then be reviewed and processed if all information in order to produce or print the 3D model is present in the 3D model file. This may include inclusion of details of material, finish, texture, accuracy, color, resolution, tolerances, and/or any other additional specification data. Some or all of this information may also be determined by file format provide. The received 3D model file may be provided in any of those file formats that may be well known to one of ordinary skill in the art such as, STL, OBJ, X3D, Collada, VRML (WRL), and PLY, or other proprietary formats. To the extent that the uploaded 3D model file requires additional information to process, the designer user 18 may be prompted through communications with the computer server 12 for additional information to supplement the 3D model file or requested to upload a substitute 3D model file for submission. It is contemplated that the 3D model file may be further reviewed to ensure 3D triangular meshes are valid, for example. This may be an automatic process or require additional user input. In addition, it is contemplated that the designer user 18 may submit multiple variations or options of the resultant 3D model, such as color, texture, size, material, etc.

Having received an acceptable 3D model file, the computer server 12 is contemplated to securely store the 3D model file. The method may include encrypting the received 3D model file. This protects the designer user 18 from having his/her 3D model files from inadvertently or intentionally being released online and significantly losing value in the process due to such availability. Such encrypting may be accomplished according to any of those methods which are well known one of ordinary skill in the art.

According to various embodiments, the prohibited 3D models may include weapons. For example, such weapons may include firearms or gun components, such as a lower receiver or ammunition magazine. It is contemplated that certain 3D models, such as weapons components, may have governmental limitations of the distribution and/or sale of the same. Moreover, non-governmental organizations may additionally desire to limit distribution and/sale of certain 3D models.

At the same time that the above-described computer platform facilitates as ease of distribution of 3D model files by designer users 18 and ease of selection by client users 22, the foregoing method of online distribution facilitates compliance with such limitations by only making those 3D model files that are not prohibited (i.e., not on the prohibited list) available for selection by the client user 22. Such compliance is regardless of whether, the client user 22 has their own 3D printer and only interacts with the computer platform to obtain the 3D model file or print specification data for printing a 3D model, or whether a print vendor user 26 is intended to be used. This is because only those 3D model files that are compliant are presented to the client user 22.

The step 106 of comparing the received 3D model file with the prohibited list for matches between the 3D model file and the prohibited 3D models of the prohibited list may be effectuated according to any of those methods known to one of ordinary skill in the art. As the simplest, the 3D model files may be “manually” reviewed by trained personnel to ensure that those 3D model files that are submitted to the computer platform do not match any of those prohibited 3D model files on the prohibited list. This would entail the review to analyze the 3D model as simulated in a computer application compatible to render a digital visualization of the 3D model. Additionally, identifying key words used in the description or attributes of the 3D model file may facilitate detection of whether the 3D model file matches any of those prohibited 3D models. The analyzing of matches may be done via a computer algorithm as programmed according to any of those methods known to one of ordinary skill in the art.

It is contemplated that the computer platform may outsource such matching review activity to a third party vendor on its behalf. Such third party vendor may even be a governmental entity. The step 106 of comparing the received 3D model file with the prohibited list for matches between the 3D model file and the prohibited 3D models of the prohibited list may be effectuated by the computer server 12 may effectuating electronic communications with third party computer systems by transmitting the 3D model or print specification data for printing a 3D model to the third party computer system and receiving an indication of whether the transmitted 3D model file is matched.

Thus having determined that the submitted 3D model file is compliant, the 3D model file may be made available to the client user community for selection. In this regard, the method further includes step 108 of establishing a client account, via a computer network 14, with a client user, such as client user 22. The client account set up process is similar to that of the designer account process as discussed above. It will be appreciated that an arbitrary number of client accounts may be established, and need not be limited to the example client users 22 or 22a-n. The method may further include step 112 receiving a selection of the 3D model file, via a computer network 14, by the client user 22. The computer server 12 may receive a selection of the 3D model file, via a computer network, by the client user 22.

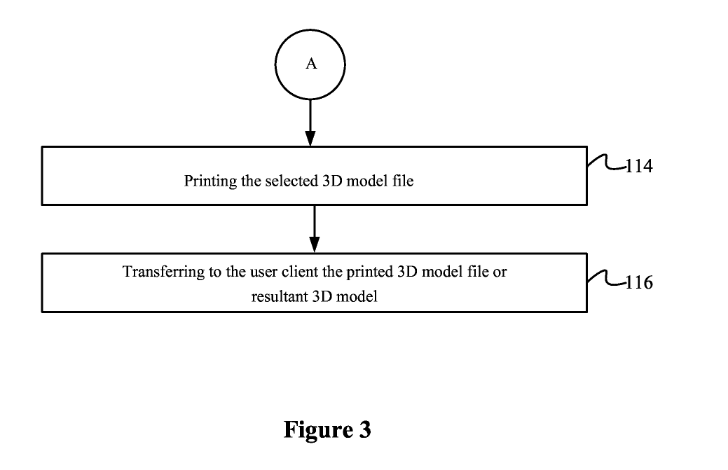

Referring now to FIG. 3 there is provided a flowchart illustrating additional steps of the method for printing 3D models in accordance the flowchart of FIG. 2. According to another embodiment, the method of FIG. 2 may continue with step 114 of printing the selected 3D model file. It is contemplated that such printing results in a printed 3D model file or resultant 3D model (i.e., a tangible item(s)). In this regard the entity associated with the hosting of the computer platform on the computer server 12 may take the action to print the selected 3D model file. The may be effectuated via an outsourced print vendor, that may or may not be a print vendor user. The method may include step 116 transferring to the user client 22 the printed 3D model file or resultant 3D model.

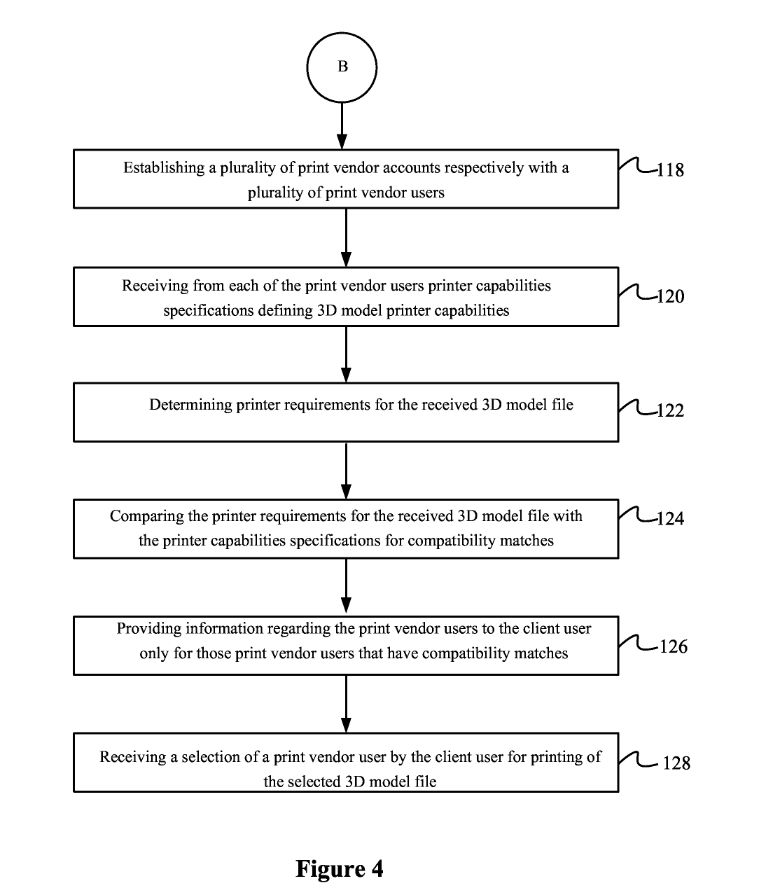

Referring now to FIG. 4 there is provided a flowchart illustrating additional steps of the method for printing 3D models in accordance the flowchart of FIG. 2. According to another embodiment, the method of FIG. 2 may continue with step 118 of establishing a plurality of print vendor accounts respectively with a plurality of print vendor users, such as print vendor users 26 and 26a-n. This may be respectively via links 26 and 26a-n with the computer network 14. The print vendor account set up process is similar to that of the designer account process as discussed above. However, additional information regarding the printer vendor (such as their website, business terms of procuring 3D printing services and other information that may be pertinent to a potential customer) would be likely be provided to the computer platform. Such information would be anticipated to be made available to the client user community. It will be appreciated that an arbitrary number of print vendor accounts may be established, and need not be limited to the example print vendor users 26 or 26a-n.

The method may further include step 120 of receiving from each of the print vendor users printer capabilities specifications defining 3D model printer capabilities. This may be via the computer network 14. The method may further include step 122 of determining printer requirements for the received 3D model file. The method may further include step 124 and comparing the printer requirements for the received 3D model file with the printer capabilities specifications for compatibility matches. The method may further include step 126 of providing information regarding the print vendor users (such as the print vendor users 26 and 26a-n) to the client user 22 only for those print vendor users (of the print vendor users 26 and 26a-n) that have compatibility matches between the printer requirements for the received 3D model file and the printer capabilities specifications. In this regard, the computer platform is able to identify which of the various print vendor users (such as print vendor users 26 and 26a-n) are able to fulfill 3D printing services in respect to a selected one of the 3D model files. The method may continue with step 128 of receiving a selection of a print vendor user (such as print vendor users 26 and 26a-n) by the client user 22 for printing of the selected 3D model file. The forgoing method is particularly useful to both the client user community and the print vendor community as this creates a marketplace for 3D printing services. 3D model files have a complex set of requirements in terms of the 3D printer capabilities that are required to produce or print a resultant 3D model or printed 3D model file. As such, the procuring of 3D printer services does not lend itself to a user-friendly exercise if attempted by one desiring a 3D model. Further, by creating an efficient marketplace for 3D printing services, this adds robustness to the distribution of the 3D model files by the designer user community.

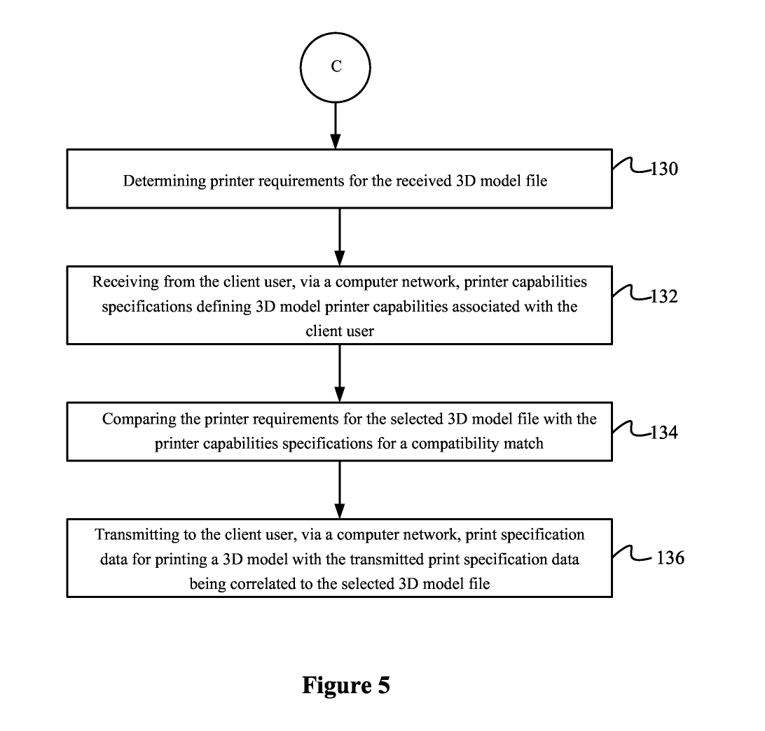

Referring now to FIG. 5 there is provided a flowchart illustrating additional steps of the method for printing 3D models in accordance the flowchart of FIG. 2. According to another embodiment, the method of FIG. 2 may continue with step 130 of determining printer requirements for the received 3D model file. The method may further include step 132 of receiving from the client user, via a computer network, printer capabilities specifications defining 3D model printer capabilities associated with the client user 22. The method may further include step 134 of comparing the printer requirements for the selected 3D model file with the printer capabilities specifications associated with the client user 22 for a compatibility match. The method may include step 136 of transmitting to the client user 22, via a computer network 14, print specification data for printing a 3D model with the transmitted print specification data being correlated to the selected 3D model file.

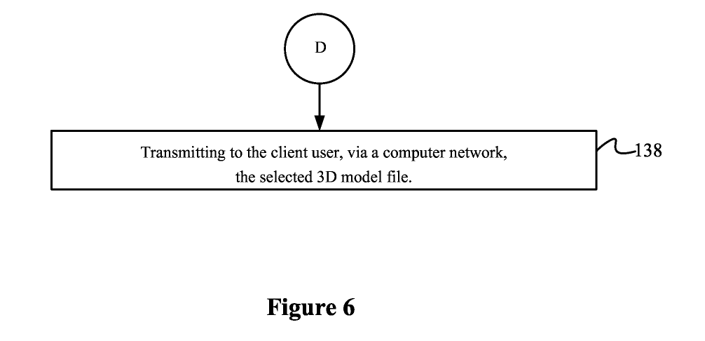

Referring now to FIG. 6 there is provided a flowchart illustrating additional steps of the method for printing 3D models in accordance the flowchart of FIG. 2. According to another embodiment, the method of FIG. 2 may continue with step 138 of transmitting to the client user, via a computer network 14, the selected 3D model file. In this regard, this method would provide for the client user 22 gaining control of the design. It is contemplated that the designer user 18 may price the related transaction accordingly. This may be particularly appealing where the client user 22 desires to perform further client side editing of the 3D model file.

It is contemplated that the computer platform as hosted by the computer server 12 may provide various ecommerce functionality to allow for the designer users 18 and 18a-n to effectively sell their designs of their 3D model files to client users 22 and 22a-n. This would be the case whether the actual 3D model files are transferred, printing services are rendered for the provision of a resultant 3D model, or print specification data is provided for self-printing. It is further contemplated that the computer platform may include functionality to provide ratings or user reviews of the various designer users and their 3D model files and the various print vendor users. Further still it is contemplated that the computer platform may allow for the client users 18 and 18a-n to edit the selected 3D model file or otherwise request certain customizations to the design as may be required by the client user. Such editing may be controlled by an authorization process of the originating designer user or facilitate further ecommerce related activity of designer customization related services.

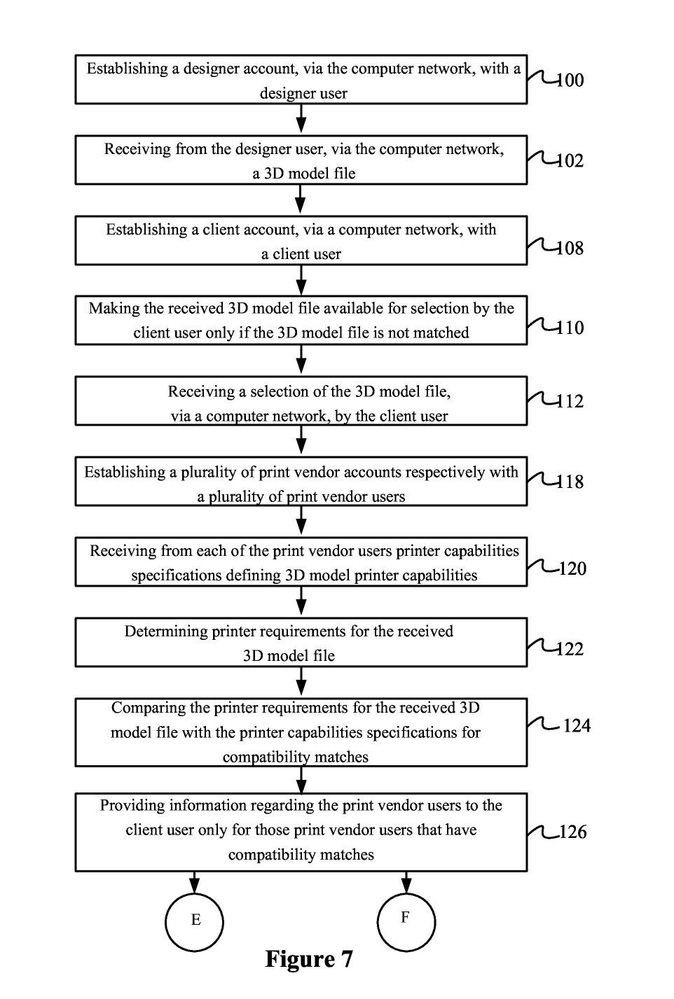

Referring now to FIG. 7, there is provided a flowchart illustrating a method for printing 3D models in accordance with another embodiment of the present disclosure. Like reference numerals indicate like elements and steps. Thus, similar referenced elements and step are as described above but with those differences noted. According to another embodiment, there is provided a method for online distribution of 3D model files for printing 3D models. The method includes step 100 of establishing a designer account, via a computer network 14, with a designer user 18. The method includes step 102 of receiving from the designer user 18, via a computer network 14, a 3D model file. The 3D model file defines printer specifications for the printing of the 3D model file. The method includes step 108 of establishing a client account, via a computer network 14, with a client user 22. The method includes step 110 of making the received 3D model file available, via a computer network 14, for selection by the client user 22. The method includes step 112 of receiving a selection of the 3D model file, via a computer network 14, by the client user 22. The method includes step 118 of establishing a plurality of print vendor accounts respectively with a plurality of print vendor users 26 and 26a-n. The method includes step 120 of receiving from each of the print vendor users 26 and 26a-n printer capabilities specifications defining 3D model printer capabilities. The method includes step 122 of determining printer requirements for the received 3D model file. The method includes step 124 of comparing the printer requirements for the received 3D model file with the printer capabilities specifications for compatibility matches. The method includes step 126 of providing information regarding the print vendor users 26 and 26a-n to the client user 22 only for those print vendor users (of the print vendor users 26 and 26a-n) that have compatibility matches between the printer requirements for the received 3D model file and the printer capabilities specifications.

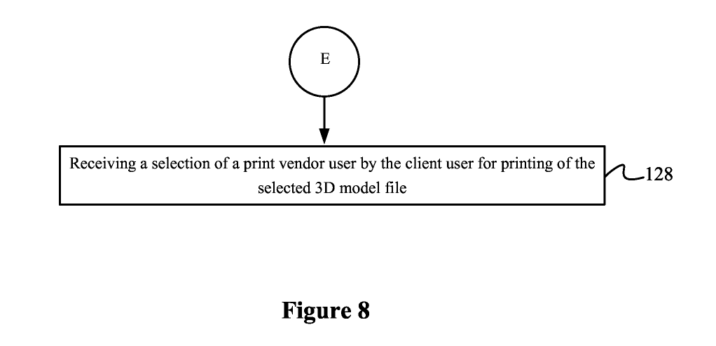

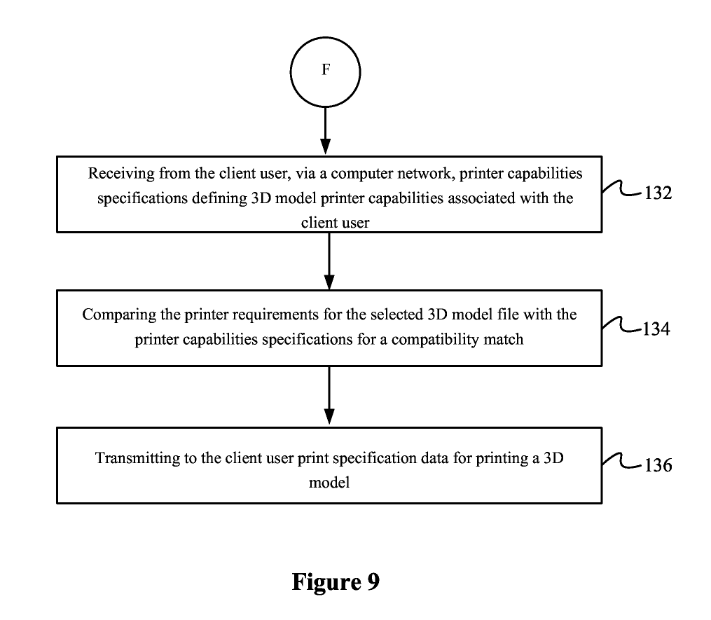

Referring now to FIG. 8 there is provided a flowchart illustrating additional steps of the method for printing 3D models in accordance the flowchart of FIG. 7. The method may include step 128 of receiving a selection of a print vendor user 26 by the client user 24 for printing of the selected 3D model file. Referring now to FIG. 9 there is provided a flowchart illustrating additional steps of the method for printing 3D models in accordance the flowchart of FIG. 7. The method may include step 132 of receiving from the client user 24, via a computer network 14, printer capabilities specifications defining 3D model printer capabilities associated with the client user 24. The method may include step 134 of comparing the printer requirements for the selected 3D model file with the printer capabilities specifications associated with the client user 24 for a compatibility match. The method may include step 136 of transmitting to the client user 24 print specification data for printing a 3D model associated with the selection.

According to yet another embodiment, there is provided an article of manufacture comprising a non-transitory program storage medium readable by a data processing apparatus. The medium embodies one or more programs of instructions executable by the data processing apparatus to perform of any of the various methods of online distribution of 3D model files as described above.

The particulars shown herein are by way of example and for purposes of illustrative discussion of the embodiments of the present disclosure only and are presented in the cause of providing what is believed to be the most useful and readily understood description of the principles and conceptual aspects. In this regard, no attempt is made to show details of the present invention with more particularity than is necessary, the description taken with the drawings making apparent to those skilled in the art how the several forms of the present invention may be embodied in practice.

What is claimed is:

1. A method for online distribution of 3D model files for printing 3D models, the method comprising:
establishing a designer account, via a computer network, with a designer user;
receiving from the designer user, via a computer network, a 3D model file, the 3D model file defining printer specifications for the printing of the 3D model file;
compiling a prohibited list of prohibited 3D models;
comparing the received 3D model file with the prohibited list for matches between the 3D model file and the prohibited 3D models of the prohibited list;
establishing a client account, via a computer network, with a client user; and
making the received 3D model file available, via a computer network, for selection by the client user only if the 3D model file is not matched with any of the prohibited 3D models of the prohibited list.

2. The method of claim 1 wherein the prohibited 3D models include weapons.

3. The method of claim 2 wherein the prohibited 3D models includes gun components.

4. The method of claim 1 further includes:
encrypting the received 3D model file.

5. The method of claim 1 further includes:
receiving a selection of the 3D model file, via a computer network, by the client user.

6. The method of claim 5 further includes:
transmitting to the client user, via a computer network, print specification data for printing a 3D model, the transmitted print specification data is correlated to the selected 3D model file.

7. The method of claim 5 further includes:
transmitting to the client user, via a computer network, the selected 3D model file.

8. The method of claim 5 further includes:
printing the selected 3D model file.

9. The method of claim 8 further includes:
transferring to the user client the printed 3D model file.

10. The method of claim 1 further includes:
establishing a plurality of print vendor accounts respectively with a plurality of print vendor users; and
receiving from each of the print vendor users printer capabilities specifications defining 3D model printer capabilities.

11. The method of claim 10 wherein the establishing of the plurality of print vendor accounts is via a computer network.

12. The method of claim 10 wherein the receiving of the printer capabilities specifications is via a computer network.

13. The method of claim 10 further includes:
determining printer requirements for the received 3D model file;
comparing the printer requirements for the received 3D model file with the printer capabilities specifications for compatibility matches; and
providing information regarding the print vendor users to the client user only for those print vendor users that have compatibility matches between the printer requirements for the received 3D model file and the printer capabilities specifications.

14. The method of claim 13 further includes:
receiving a selection of the 3D model file, via a computer network, by the client user; and
receiving a selection of a print vendor user by the client user for printing of the selected 3D model file.

15. The method of claim 1 further includes:
determining printer requirements for the received 3D model file;
receiving a selection of the 3D model file, via a computer network, by the client user; and
receiving from the client user printer, via a computer network, capabilities specifications defining 3D model printer capabilities associated with the client user; and
comparing the printer requirements for the selected 3D model file with the printer capabilities specifications for a compatibility match.

16. A method for online distribution of 3D model files for printing 3D models, the method comprising:
establishing a designer account, via a computer network, with a designer user;
receiving from the designer user, via a computer network, a 3D model file, the 3D model file defining printer specifications for the printing of the 3D model file;
establishing a client account, via a computer network, with a client user;
making the received 3D model file available, via a computer network, for selection by the client user;
receiving a selection of the 3D model file, via a computer network, by the client user;
establishing a plurality of print vendor accounts respectively with a plurality of print vendor users;
receiving from each of the print vendor users printer capabilities specifications defining 3D model printer capabilities;
determining printer requirements for the received 3D model file;
comparing the printer requirements for the received 3D model file with the printer capabilities specifications for compatibility matches; and
providing information regarding the print vendor users to the client user only for those print vendor users that have compatibility matches between the printer requirements for the received 3D model file and the printer capabilities specifications.

17. The method of claim 16 further includes:
receiving a selection of a print vendor user by the client user for printing of the selected 3D model file.

18. The method of claim 16 further includes:
receiving from the client user, via a computer network, printer capabilities specifications defining 3D model printer capabilities associated with the client user;
comparing the printer requirements for the selected 3D model file with the printer capabilities specifications associated with the client user for a compatibility match; and
transmitting to the client user print specification data for printing a 3D model associated with the selection.
